(19) United States
(12) Patent Application Publication
(10) Pub. No.: US 2009/0317998 A1
(43) Pub. Date: Dec. 24, 2009

(54) Cold cathode fluorescent lamp connecting structure for backlight module

(76) Inventor: Ji-Dong Yu, Wujiang City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,707

(22) Filed: Jun. 24, 2008

(51) Int. Cl. H01R 33/02

(52) U.S. Cl. 439/226

(57) ABSTRACT

A cold cathode fluorescent lamp connecting structure for a backlight module includes a cold cathode fluorescent lamp connecting unit having a cold cathode fluorescent lamp insertion end and a wire inlet. At least one cold cathode fluorescent lamp socket communicable with the wire inlet is formed at the cold cathode fluorescent lamp insertion end to extend into the cold cathode fluorescent lamp connecting unit in a extending predetermined direction for a cold cathode fluorescent lamp to insert into the cold cathode fluorescent lamp socket. The cold cathode fluorescent lamp connecting unit is characterized in that at least one slit is formed on the cold cathode fluorescent lamp connecting unit to extend in the same extending direction as the cold cathode fluorescent lamp insertion socket by a predetermined length and communicate with the cold cathode fluorescent lamp socket. A wire can be extended into the cold cathode fluorescent lamp connection unit via the wire inlet and pulled out of the cold cathode fluorescent lamp connecting unit via the slit to enable convenient connection and maintenance of the cold cathode fluorescent lamp.

### FIELD OF THE INVENTION

The present invention relates to a cold cathode fluorescent lamp connecting structure, and more particularly to a cold cathode fluorescent lamp connecting structure for a backlight module.

### BACKGROUND OF THE INVENTION

It is known that a conventional cold cathode fluorescent lamp connecting unit has many defects. For example, in installation procedure, it is difficult to smoothly extend a wire through the cold cathode fluorescent lamp connecting unit and the wire is likely to break when being extended through the cold cathode fluorescent lamp connecting unit. In addition, the conventional cold cathode fluorescent lamp connecting unit is so tight that a big effort is required for inserting the cold cathode fluorescent lamp into the cold cathode fluorescent lamp connecting unit. During this process, electrodes on the cold cathode fluorescent lamp and the wire are easily subject to deformation and damage. On the other hand, in case of failure of the cold cathode fluorescent lamp, it is also difficult to detach the cold cathode fluorescent lamp from the cold cathode fluorescent lamp connecting unit for repair. All the above defects lead to increased manufacturing cost of the backlight module.

Taiwanese Patent Number 1292502 discloses a cold cathode fluorescent lamp connecting structure including a cold cathode fluorescent lamp protective member. The wire is first hooked and welded to the electrodes of the cold cathode fluorescent lamp outside the cold cathode fluorescent lamp protective member. Then, the cold cathode fluorescent lamp along with the wire is forced into the cold cathode fluorescent lamp protective member through a split thereof. Since the split has a width smaller than the diameter of the cold cathode fluorescent lamp, the welded sections of the cold cathode fluorescent lamp and the wire are easily damaged when the cold cathode fluorescent lamp and the wire are forced into the protective member.

Therefore, it is desirable to develop an improved cold cathode fluorescent lamp connecting structure for backlight module to overcome the problems in the conventional cold cathode fluorescent lamp connecting structure, such as deformed or broken wire and damaged welded points at the electrodes of the cold cathode fluorescent lamp caused by the tightness of the cold cathode fluorescent lamp connecting structure.

### SUMMARY OF THE INVENTION

A primary object of the present invention is to provide a cold cathode fluorescent lamp connecting structure for backlight module. The structure includes a cold cathode fluorescent lamp connecting unit to protect welded points between a cold cathode fluorescent lamp and a wire against damage during the process of wiring, so that the cold cathode fluorescent lamp can be efficiently installed at reduced time to lower the manufacturing cost of the backlight module.

A further object of the present invention is to provide a cold cathode fluorescent lamp connecting structure for backlight module that includes a low-friction cold cathode fluorescent lamp connecting unit for a cold cathode fluorescent lamp to be connected to or disconnected from a wire easily without causing deformed or broken wire, and thereby increases the reliability of a backlight module product.

To achieve the above and other objects, the cold cathode fluorescent lamp connecting structure for backlight module according to the present invention includes a cold cathode fluorescent lamp connecting unit having a cold cathode fluorescent lamp insertion end and a wire inlet. At least one cold cathode fluorescent lamp socket communicable with the wire inlet is formed at the cold cathode fluorescent lamp insertion end to extend into the cold cathode fluorescent lamp connecting unit in a predetermined extending direction for a cold cathode fluorescent lamp to insert into the cold cathode fluorescent lamp socket. The cold cathode fluorescent lamp connecting unit is characterized in that at least one slit is formed on the cold cathode fluorescent lamp connecting unit to extend in the same extending direction as the cold cathode fluorescent lamp insertion socket by a predetermined length and communicate with the cold cathode fluorescent lamp socket. The slit gives the cold cathode fluorescent lamp socket a certain degree of elasticity. Therefore, when a cold cathode fluorescent lamp is inserted into or pulled out from the cold cathode fluorescent lamp socket, the frictional force between the cold cathode fluorescent lamp and the socket is reduced to facilitate easy connection and disconnection of the cold cathode fluorescent lamp to and from the wire.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a cold cathode fluorescent lamp connecting unit according to a first embodiment of the present invention;

FIG. 2 is a top view of FIG. 1;

FIG. 3 is a sectional view taken along line 3-3 of FIG. 1;

FIG. 4 is a sectional view taken along line 4-4 of FIG. 1;

FIG. 5 is a perspective view showing the connection of cold cathode fluorescent lamps to the cold cathode fluorescent lamp connecting unit of FIG. 1;

FIG. 6 is a sectional view showing the connection of a cold cathode fluorescent lamp with a wire via the cold cathode fluorescent lamp connecting unit;

FIG. 7 is a perspective view of a cold cathode fluorescent lamp connecting unit according to a second embodiment of the present invention; and

FIG. 8 is a perspective view of a cold cathode fluorescent lamp connecting unit according to a third embodiment of the present invention.

### DETAILED DESCRIPTION OF THE PREFERRED EMBODIMENTS

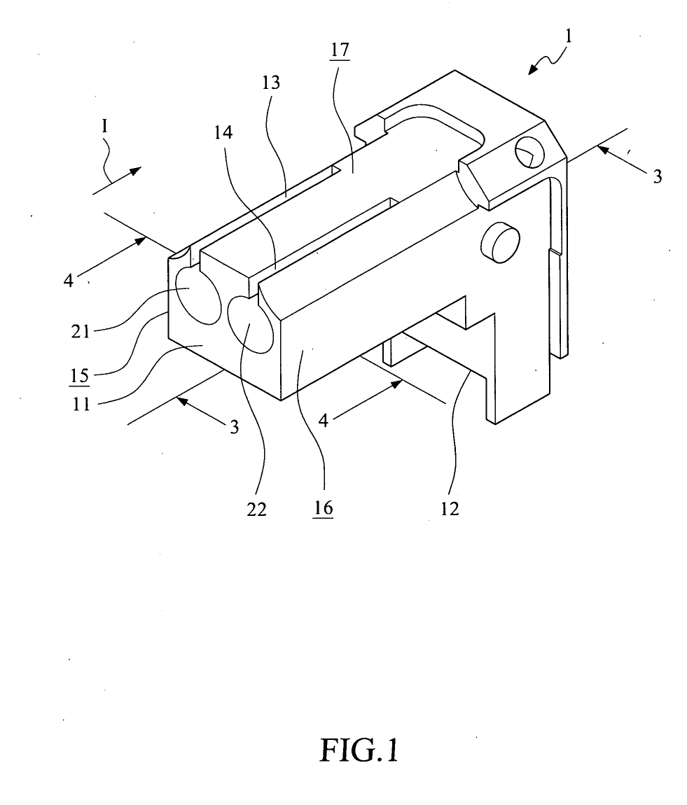

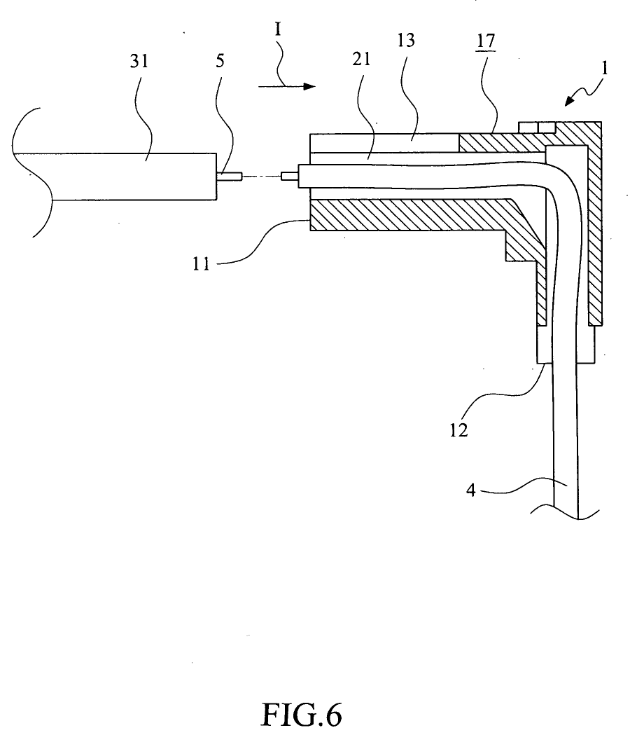

Please refer to FIG. 1 that is a perspective view of a cold cathode fluorescent lamp connecting unit 1 according to a first embodiment of the present invention. As shown, the cold cathode fluorescent lamp connecting unit 1 has a cold cathode fluorescent lamp insertion end 11 and a wire inlet 12. The cold cathode fluorescent lamp insertion end 11 is formed with a first cold cathode fluorescent lamp socket 21 and a second cold cathode fluorescent lamp socket 22 communicating with the wire inlet 12. A first slit 13 and a second slit 14 are formed on a top of the first and second cold cathode fluorescent lamp sockets 21, 22, respectively, to communicate with the first and second cold cathode fluorescent lamp sockets 21, 22. In addition, a first wire outlet 23 and a second wire outlet 24 are formed on the cold cathode fluorescent lamp connecting unit 1 opposite to but communicating with the wire inlet 12. Two cold cathode fluorescent lamps (not shown) can be separately inserted into the first and second cold cathode fluorescent lamp sockets 21, 22 in an extending direction indicated by the arrow I in FIG. 1. When two wires 4 (as shown in FIG. 6) have been properly installed on the cold cathode fluorescent lamp connecting unit 1, they would respectively have one end projected from the first and second cold cathode fluorescent lamp sockets 21, 22 at the cold cathode fluorescent lamp insertion end 11 for connecting to the electrode welding points on the two cold cathode fluorescent lamps (not shown). The other end of the two wires 4 may be pulled out via the first and second wire outlets 23, 24 for respectively connecting to the electrode welding points at the other end of the two cold cathode fluorescent lamps.

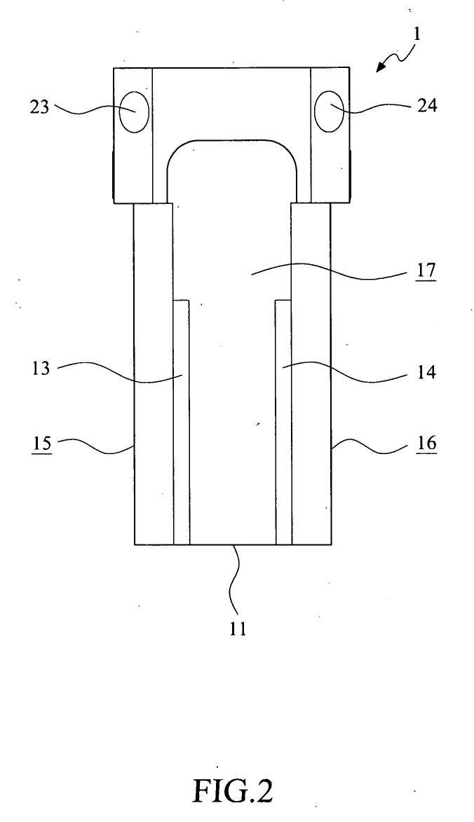

Please refer to FIG. 2 that is a top view of FIG. 1. When the wires 4 are fitted into the wire inlet 12, the wires 4 are pulled out of the cold cathode fluorescent lamp connecting unit 1 via the slits 13, 14 on the cold cathode fluorescent lamp sockets 21, 22 and via the wire outlets 23, 24.

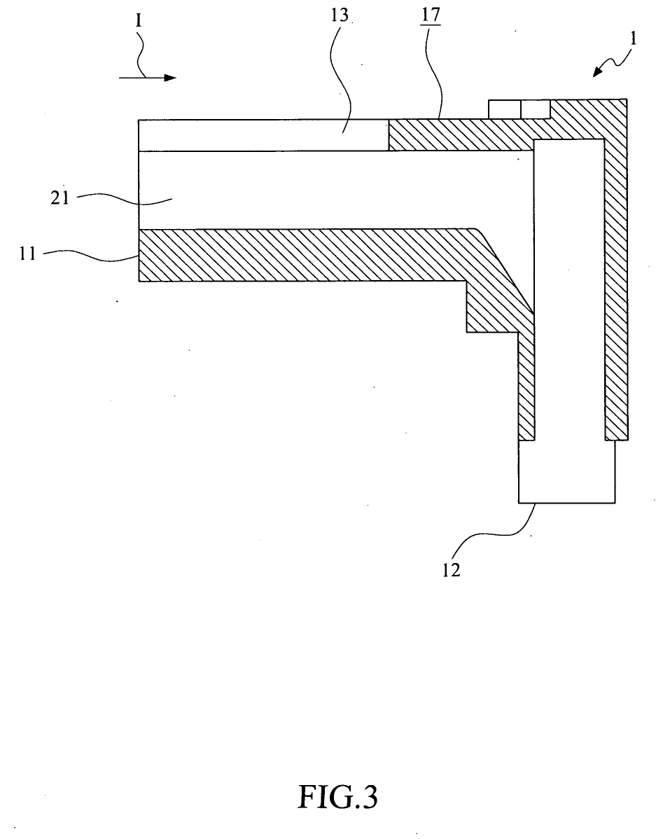

FIG. 3 is a sectional view taken along line 3-3 of FIG. 1. Please now refer to FIG. 3. When the wires 4 extended toward the first and second cold cathode fluorescent lamp sockets 21, 22 reach the slits 13, 14, a predetermined length of the wires 4 can be pulled out of the cold cathode fluorescent lamp connecting unit 1 via the first and second slits 13, 14, and then the wires are pushed back a little bit into the cold cathode fluorescent lamp sockets 21, 22 until front ends of the wires are protruded from the cold cathode fluorescent lamp insertion end 11.

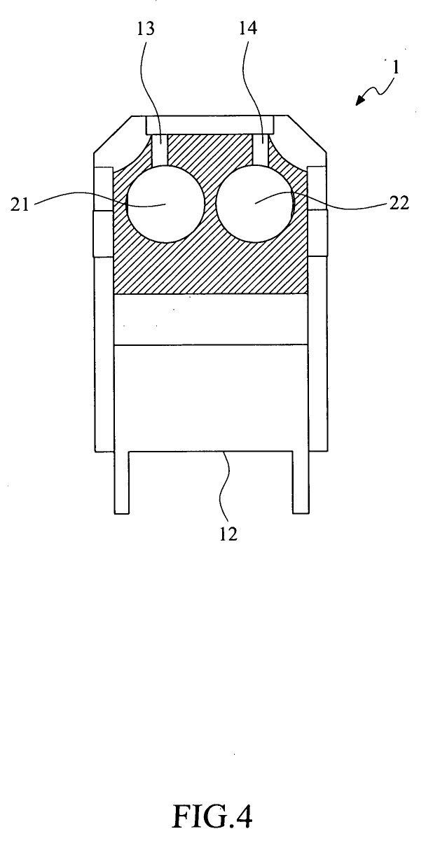

FIG. 4 is a sectional view taken along line 4-4 of FIG. 1. When the wires are extended into the cold cathode fluorescent lamp connecting unit 1 via the wire inlet 12, the first and second slits 13, 14 on the first and second cold cathode fluorescent lamp sockets 21, 22, respectively, allow the wires to be pulled out of the cold cathode fluorescent lamp connecting unit 1 via the slits 13, 14 without becoming deformed or broken before the installation of cold cathode fluorescent lamps.

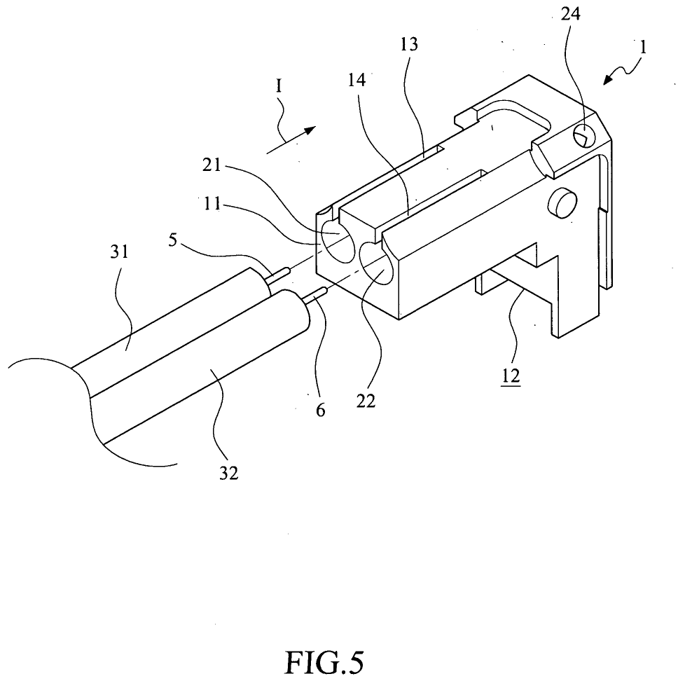

FIG. 5 is a perspective view showing the connection of two cold cathode fluorescent lamps 31, 32 to the cold cathode fluorescent lamp connecting unit 1 by welding the wires (not shown) to electrodes 5, 6 of the cold cathode fluorescent lamps 31, 32, respectively.

When the cold cathode fluorescent lamps 31, 32 are inserted into the cold cathode fluorescent lamp sockets 21, 22 in the extending direction I, since the provision of the slits 13, 14 gives the cold cathode fluorescent lamp sockets 21, 22 a certain degree of elasticity, the cold cathode fluorescent lamps 31, 32 could be more easily inserted into or pulled out from the cold cathode fluorescent lamp sockets 21, 22 with a reduced friction between the cold cathode fluorescent lamps and the cold cathode fluorescent lamp sockets.

FIG. 6 is a sectional view showing the connection of the cold cathode fluorescent lamp 31 with one wire 4 via the cold cathode fluorescent lamp connecting unit 1. When the wire 4 is extended into the wire inlet 12 toward the first cold cathode fluorescent lamp socket 21, a length of the wire 4 is pulled out of the cold cathode fluorescent lamp connecting unit 1 via the first slit 13 and then a shorter length of the protruded wire is pushed back into the cold cathode fluorescent lamp socket 21 again. The front end of the wire 4 is finally protruded from the cold cathode fluorescent lamp insertion end 11 and can be conveniently welded to the electrode 5 of the cold cathode fluorescent lamps 31.

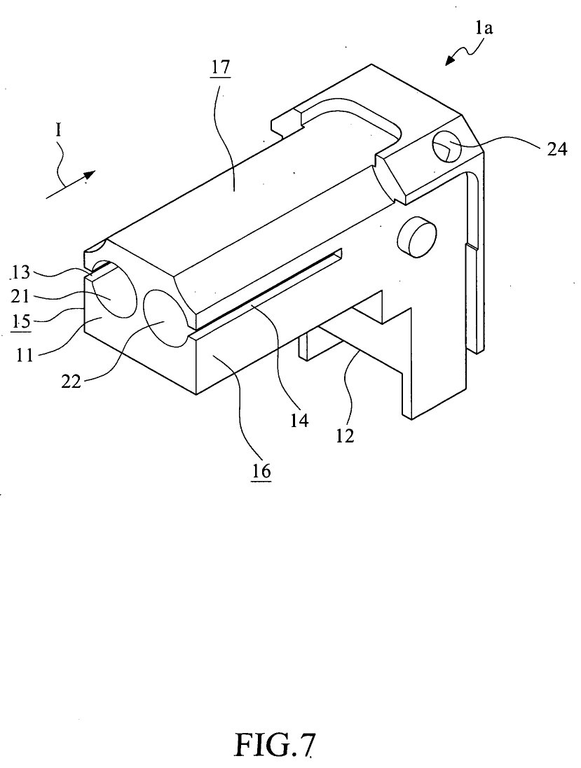

FIG. 7 is a perspective view showing a cold cathode fluorescent lamp connecting unit 1a according to a second embodiment of the present invention. The second embodiment is generally structurally similar to the first embodiment, except that the first and second slits 13, 14 in the second embodiment are respectively formed on two sidewalls 15, 16 of the cold cathode fluorescent lamp connecting unit 1a.

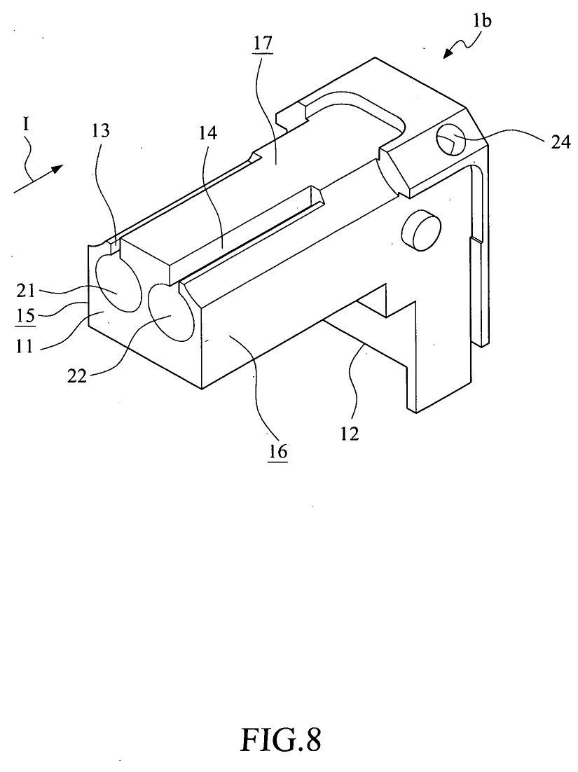

FIG. 8 is a perspective view showing a cold cathode fluorescent lamp connecting unit 1b according to a third embodiment of the present invention. The third embodiment is generally structurally similar to the first embodiment, except that the first and second slits 13, 14 in the third embodiment are formed along junctions of a top 17 and two sidewalls 15, 16 of the cold cathode fluorescent lamp connecting unit 1b.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cold cathode fluorescent lamp connecting structure for a backlight module, comprising:
a cold cathode fluorescent lamp connecting unit having a cold cathode fluorescent lamp insertion end and a wire inlet;
at least one cold cathode fluorescent lamp socket being formed at the cold cathode fluorescent lamp insertion end to extend into the cold cathode fluorescent lamp connecting unit in a predetermined extending direction for a cold cathode fluorescent lamp to insert into the cold cathode fluorescent lamp socket, and the cold cathode fluorescent lamp socket being communicable with the wire inlet; and
at least one slit formed on the cold cathode fluorescent lamp connecting unit to extend along the extending direction as the cold cathode fluorescent lamp insertion socket by a predetermined length and communicate with the cold cathode fluorescent lamp socket.

2. The cold cathode fluorescent lamp connecting structure as claimed in claim 1, wherein the slit is formed on a top of the cold cathode fluorescent lamp connecting unit.

3. The cold cathode fluorescent lamp connecting structure as claimed in claim 1, wherein the slit is formed on a sidewall of the cold cathode fluorescent lamp connecting unit.

4. The cold cathode fluorescent lamp connecting structure as claimed in claim 1, wherein the slit is formed along a junction of a top and a sidewall of the cold cathode fluorescent lamp connecting unit.
